(19) United States
(12) Patent Application Publication
(10) Pub. No.: US 2011/0293477 A1
(43) Pub. Date: Dec. 1, 2011

(54) AUTOMATIC ANALYZER

(76) Inventors: Kazunori Yamazawa, Mito (JP); Yoshiyuki Tanaka, Hitachinaka (JP); Taku Sakazume, Hitachinaka (JP)

(21) Appl. No.: 13/142,033

(22) PCT Filed: Dec. 4, 2009
(86) PCT No.: PCT/JP2009/006614

§ 371 Date: Jul. 14, 2011

(30) Foreign Application Priority Data
Dec. 26, 2008 (JP) 2008-331828 2008

(51) Int. Cl. G01N 31/00

(52) U.S. Cl. 422/67

(57) ABSTRACT

Disclosed is an automatic analyzer that is capable of executing a plurality of different measurement sequences in a sequential, parallel manner, has a check function for avoiding simultaneous mechanical equipment use and interference between the mechanical equipment, incorporates a plurality of different transport mechanism operation schemes for transporting a reaction vessel to the mechanical equipment, and minimizes a decrease in the throughput by choosing an appropriate transport mechanism operation scheme as needed.

Before initiating a measurement sequence for a requested analytical test, the automatic analyzer checks for simultaneous use of the mechanical equipment. If it is judged that simultaneous mechanical equipment use would result, the automatic analyzer postpones the start of the requested analytical test. This makes it possible to avoid simultaneous mechanical equipment use and make a proper analysis. Further, the automatic analyzer incorporates a logic that initiates an analytical test irrelevant to simultaneous equipment use prior to the other analytical tests when a plurality of different analytical tests are requested. This makes it possible to make efficient analyses.

### TECHNICAL FIELD

The present invention relates to an automatic analyzer that analyzes blood, urine, and other biological samples. More specifically, the present invention relates to an automatic analyzer that has a measurement sequence in which a series of operations, such as sample sampling, reagent addition, stirring, incubation, and electrical signal measurement, is performed to analyze a target component in a sample, and discretely initiates the measurement sequence at fixed time intervals to conduct a plurality of analytical tests in a sequential, parallel manner.

### BACKGROUND ART

In general, an apparatus for automatically analyzing blood, urine, and other biological samples with a reagent has a measurement sequence in which a series of operations, such as sample sampling, reagent addition, stirring, incubation, and electrical signal measurement, are performed to analyze a target component in a sample, and discretely initiates the measurement sequence at fixed time intervals to conduct a plurality of analytical tests in a sequential, parallel manner. An example of the above-described automatic analyzer is described in Patent Document 1.

Each model of the above-described automatic analyzer usually has only one type of measurement sequence. Although some conventional technologies make it possible to measure a plurality of items that differ in reagent addition timing and required response time (incubation time), they merely retain a maximum number of reagent addition timings and a maximum duration of response time and omit irrelevant portions as appropriate. Therefore, they basically repeat a measurement sequence having a fixed pattern. In other words, there was no means of enabling one automatic analyzer to perform measurement sequences having different patterns.

### PRIOR ART LITERATURE

### Patent Document

Patent Document 1: JP-A-5-164763

### SUMMARY OF THE INVENTION

### Problems to be Solved by the Invention

In recent years, reagents for analyzing, for instance, blood and urine have been improved. In addition, medical examinations and emergency tests have been diversified. Therefore, a plurality of measurement sequences for analyzing a target component have been developed. However, each model of conventional automatic analyzers generally supports only one type of measurement sequence. Therefore, when making an analysis in a different measurement sequence, it is necessary to use a different analyzer. This will cause various problems such as an increase in the cost of a test room and an increase in the space occupied by the analyzers.

Further, as the conventional automatic analyzers repeatedly execute one type of measurement sequence in order to maximize their processing capacity, they are usually designed to optimize the layout of mechanical equipment. Therefore, an attempt to perform different sequences in a sequential, parallel manner with one analyzer will incur simultaneous mechanical equipment use and operational interference between mechanical equipment.

Conversely, simultaneous mechanical equipment use and operational interference between mechanical equipment can be avoided by waiting until the completion of one measurement sequence and then initiating another measurement sequence. However, this method is not practical because it will drastically decrease the analytical processing capacity (throughput) of the analyzers.

An object of the present invention is to provide an automatic analyzer that can run a plurality of different measurement sequences, the automatic analyzer having a check function to avoid simultaneous mechanical equipment use and operational interference between mechanical equipment, the automatic analyzer incorporating a plurality of different transport mechanism operation schemes for transporting a reaction vessel to the mechanical equipment, the automatic analyzer minimizing a decrease in the throughput by choosing an appropriate operation scheme as needed.

### Means for Solving the Problems

A common automatic analyzer executes one type of reaction sequence by combining a rotating operation of a reaction vessel transport mechanism, a sampling operation of a sample pipetting mechanism, a stirring operation of a stirring mechanism, and other operations of mechanical equipment. Each unit of mechanical equipment repeats one predetermined type of operation. The operations of various units of mechanical equipment are combined so that one type of measurement sequence is repeated to successively conduct a plurality of tests.

The present invention addresses the aforementioned problems by switching to an additional mechanical operation from a previously fixed mechanical operation in a situation where a different measurement sequence needs to be performed for a particular test.

The present invention can be applied to an automatic analyzer that includes, for instance, a disc-shaped reaction vessel transport mechanism and places a reaction vessel on its circumference. In this instance, the disc-shaped reaction vessel transport mechanism rotates to transport a reaction vessel to a sample sampling mechanism, a stirring mechanism, or other mechanical equipment secured to an appropriate position outside the disc-shaped reaction vessel transport mechanism. This rotary motion is usually fixed in a conventional automatic analyzer. This fixed motion is repeated to successively conduct a plurality of tests. The present invention changes the amount and direction of rotation to settings different from normal ones only when a different measurement sequence needs to be used for a particular measurement. This enables one automatic analyzer to make measurements in two or more different measurement sequences.

However, as for the conventional automatic analyzers, which repeatedly initiate one type of measurement sequence in a discrete manner to maximize their processing capacity, their mechanical equipment is secured to an optimum position. Therefore, if different measurement sequences coexist, proper analyses might not be made because of simultaneous equipment use for a plurality of different tests. To address the above problem, the present invention incorporates a check logic to check for simultaneous equipment use. Before the start of a scheduled measurement sequence, the check logic judges whether an incubation operation is to be performed, and checks for simultaneous equipment use. If it is judged that simultaneous equipment use will result, the check logic postpones the start of an associated test. This makes it possible to avoid simultaneous equipment use and make proper analyses.

In addition, the present invention incorporates a logic that initiates tests irrelevant to simultaneous equipment use prior to the other tests when a plurality of different tests are requested. This makes it possible to make efficient analyses.

### Effects of the Invention

Each of conventional automatic analyzers generally supports only one type of measurement sequence. Therefore, when making an analysis in a different measurement sequence, it is necessary to use a different analyzer. This will cause various problems such as an increase in the cost of a test room and an increase in the space occupied by the analyzers.

Further, when one conventional analyzer is used to make analyses in a parallel manner in different sequences, simultaneous mechanical equipment use and interference between mechanical equipment result. Therefore, it is necessary to wait until the completion of one measurement sequence and then initiate another measurement sequence. However, the use of this method drastically decreases the analytical processing capacity (throughput). The present invention enables one automatic analyzer to operate a plurality of different measurement sequences. It can therefore be expected that the present invention will produce various effects such as a reduction in the cost of a test room and a decrease in the space occupied by analyzer.

Further, the present invention provides an automatic analyzer that has a check function for avoiding simultaneous mechanical equipment use and interference between mechanical equipment, incorporates a plurality of different transport mechanism operation schemes for transporting a reaction vessel to the mechanical equipment, and minimizes a decrease in the throughput by choosing an appropriate operation scheme as needed.

Furthermore, the present invention offers an advantage for automatic analyzer manufacturers. The present invention makes it possible to modify a conventional automatic analyzer, which supports only one type of measurement sequence, with limited labor and at a low cost for the purpose of obtaining an automatic analyzer capable of providing a plurality of measurement sequences.

### BRIEF DESCRIPTION OF THE DRAWINGS

FIG. 1 is a diagram illustrating an automatic analyzer according to an embodiment of the present invention, which makes analyses by rotating a disc-shaped reaction vessel transport mechanism, and examples of measurement sequences that are performed with the automatic analyzer.

FIG. 2 is a diagram illustrating an example in which identical measurement sequences are discretely initiated to conduct a plurality of analytical tests in a sequential, parallel manner.

FIG. 3 is a diagram illustrating an automatic analyzer according to an embodiment of the present invention, which makes analyses by rotating a disc-shaped reaction vessel transport mechanism, and an example in which the automatic analyzer is used to conduct a plurality of analytical tests by successively executing one type of measurement sequence.

FIG. 4 is a diagram illustrating an example in which a plurality of analytical tests are coincidentally conducted in a sequential, parallel manner by discretely initiating two different measurement sequences that coexist.

FIG. 5 is a diagram illustrating an automatic analyzer according to an embodiment of the present invention, which makes analyses by rotating a disc-shaped reaction vessel transport mechanism, and an example in which the automatic analyzer is used to conduct a plurality of analytical tests by successively executing two different measurement sequences.

FIG. 6 is a flowchart illustrating a logic that avoids simultaneous use of mechanical equipment necessary for analyses and interference between the mechanical equipment and postpones the start of a sequence when two different measurement sequences coexist.

FIG. 7 is a diagram illustrating an example in which the logic shown in FIG. 6 is applied to postpone the start of a sequence until it is possible to avoid the simultaneous use of mechanical equipment necessary for analyses and the interference between the mechanical equipment.

FIG. 8 is a flowchart illustrating a logic that initiates tests irrelevant to the simultaneous use of mechanical equipment necessary for analyses and the interference between the mechanical equipment prior to the other tests when two or more different measurement sequences are to be used for measurement purposes.

### MODE FOR CARRYING OUT THE INVENTION

An automatic analyzer according to an embodiment of the present invention will now be described with reference to the accompanying drawings.

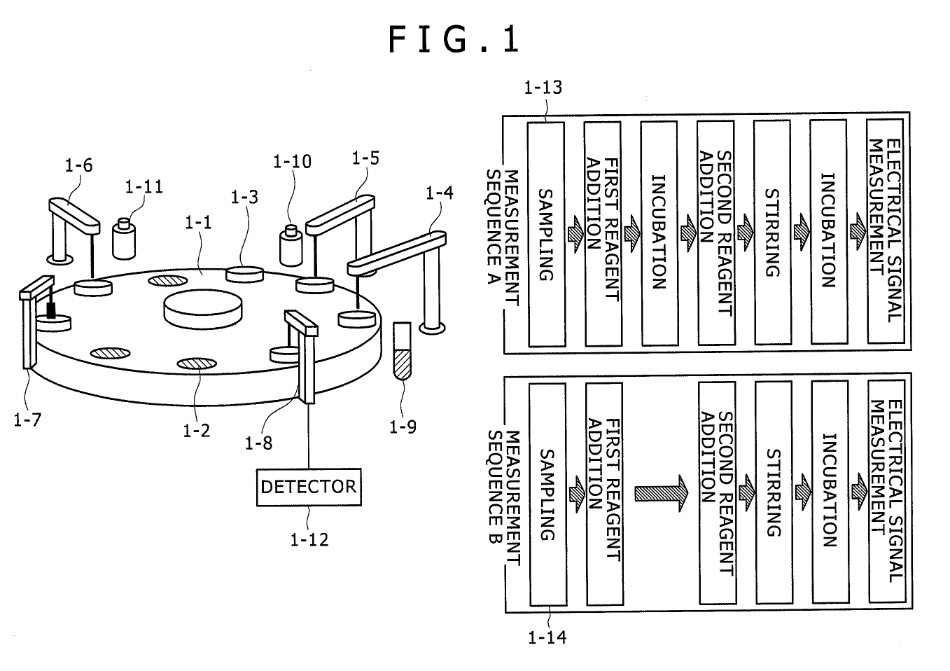

FIG. 1 shows one embodiment of the present invention. In FIG. 1, the reference numeral 1-1 denotes a disc-shaped reaction vessel transport mechanism. Reaction vessel setting positions 1-2 are arranged on the circumference of the reaction vessel transport mechanism.

The reference numeral 1-3 denotes a reaction vessel that is actually placed in a setting position. The reaction vessel mounting mechanism rotates to transport a reaction vessel to the position of a mechanism necessary for analysis. The reference numeral 1-4 denotes a sample pipetting mechanism, which suctions a sample from a sample vessel 1-9 and discharges the suctioned sample into a reaction vessel. The reference numeral 1-5 denotes a first reagent pipetting mechanism, which suctions a reagent from a first reagent vessel 1-10 and discharges the suctioned reagent into a reaction vessel. Similarly, the reference numeral 1-6 denotes a second reagent pipetting mechanism, which suctions a reagent from a second reagent vessel 1-11 and discharges the suctioned reagent into a reaction vessel. The reference numeral 1-7 denotes a stirring mechanism, which stirs a sample and reagent in a reaction vessel. The reaction vessel transport mechanism 1-1 is maintained at a constant temperature. Therefore, while a reaction vessel is set on the reaction vessel transport mechanism, a mixed liquid in the reaction vessel is subjected to a chemical reaction at a constant temperature. This process is called “incubation.” After the incubation is performed for a predetermined period of time, a reaction solution is suctioned by a reaction solution suction mechanism 1-8 and forwarded to a detector 1-12. The detector 1-12 converts, for instance, the luminescence amount and absorbance of the reaction solution to an electrical signal, and measures the electrical signal to quantify a target component.

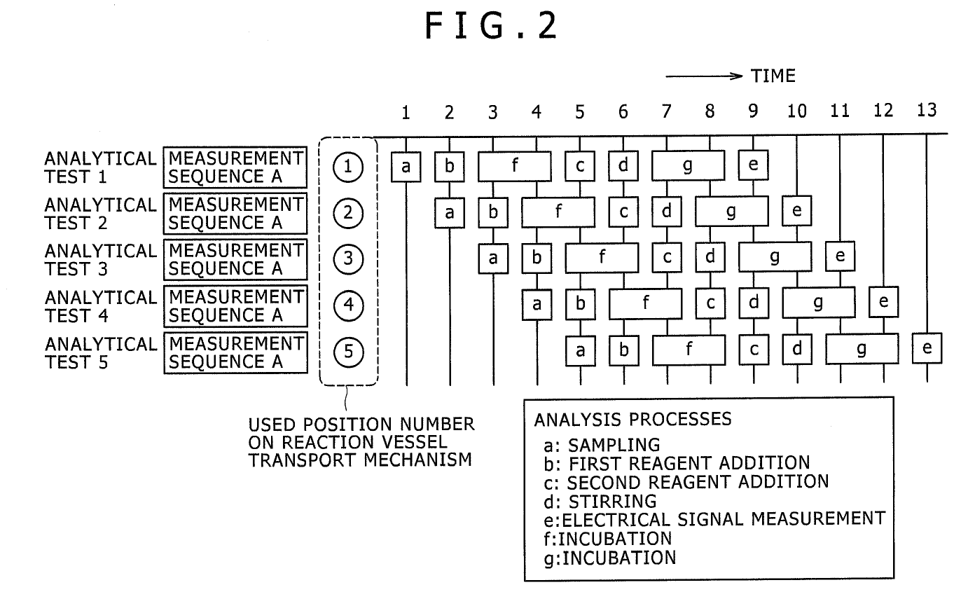

As examples of the above-described measurement sequence in which a series of operations is performed, measurement sequence A and measurement sequence B, which have different patterns, are respectively designated at 1-13 and 1-14 in FIG. 1. The present invention enables one apparatus to execute two or more different measurement sequences, which have different patterns. Before explaining about a case where two or more different measurement sequences are executed, a case where analyses are made by executing one type of measurement sequence (measurement sequence A) will be described with reference to FIG. 2.

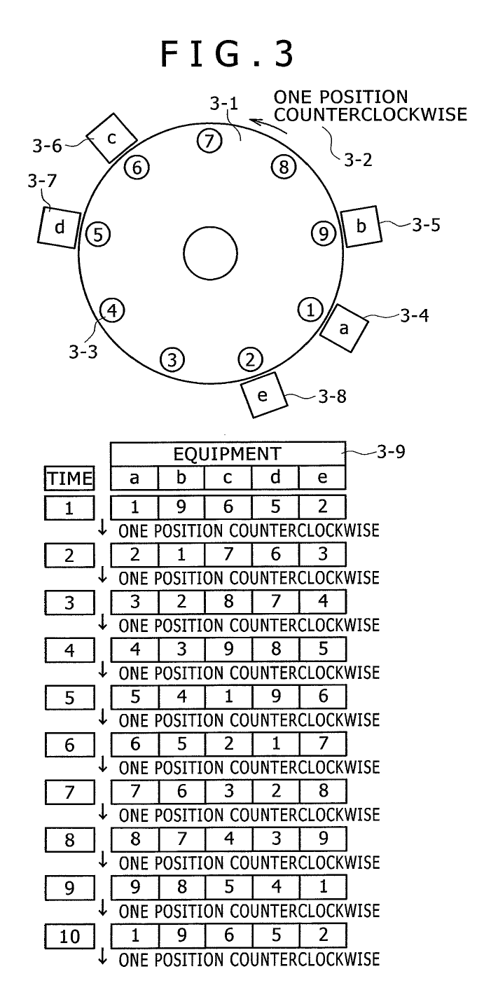

One measurement sequence is executed to conduct one analytical test. Only one unit of mechanical equipment is available for analysis at a time. Therefore, the efficiency of analysis is maximized by initiating a measurement sequence at fixed time intervals for various tests as shown in FIG. 2. The relationship between the measurement sequence and mechanical operations will now be described in detail with reference to FIG. 3.

The reference numeral 3-1 denotes a reaction vessel transport mechanism. The reference numeral 3-3 denotes a reaction vessel setting position and its number. One test is assigned to each position. In a situation where a certain test is assigned, for instance, to position 1, a measurement sequence starts when a reaction vessel is set in position 1. The reference numeral 3-2 denotes the amount and direction of rotation that is provided by the reaction vessel transport mechanism at fixed time intervals. As indicated at 3-2, when the reaction vessel transport mechanism rotates one position counterclockwise at fixed time intervals, various analysis processes are sequentially performed to execute one measurement sequence. More specifically, one measurement sequence is executed by conducting a sampling operation with the sample pipetting mechanism, adding a first reagent with the first reagent pipetting mechanism, adding a second reagent with the second reagent pipetting mechanism, stirring with the stirring mechanism, and suctioning a reaction solution and measuring an electrical signal with the reaction solution suction mechanism. Positions 2, 3, and beyond are then sequentially used to conduct the associated analytical tests one by one. Upon completion of one measurement sequence, the reaction vessel is discarded so as to use the positions for new analytical tests.

The reference numeral 3-9 denotes the relationship between various units of mechanical equipment and the positions of the reaction vessel transport mechanism that are stopped at the positions of the various units of mechanical equipment at fixed time intervals when a plurality of analytical tests are successively conducted. As shown in FIG. 3, successive analyses can be made in a single operational pattern in which the reaction vessel transport mechanism rotates one position counterclockwise at fixed time intervals.

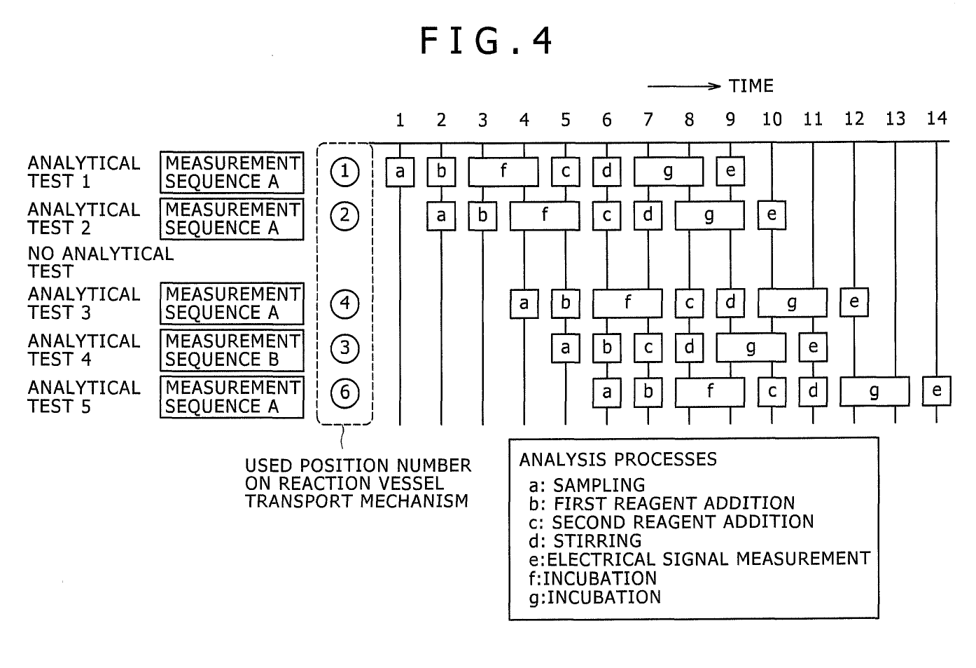

A case where two or more different measurement sequences are executed to make analyses in accordance with the present invention will now be described with reference to FIG. 4. In an example shown in FIG. 4, it is assumed that two measurement sequences (measurement sequences A and B) coexist.

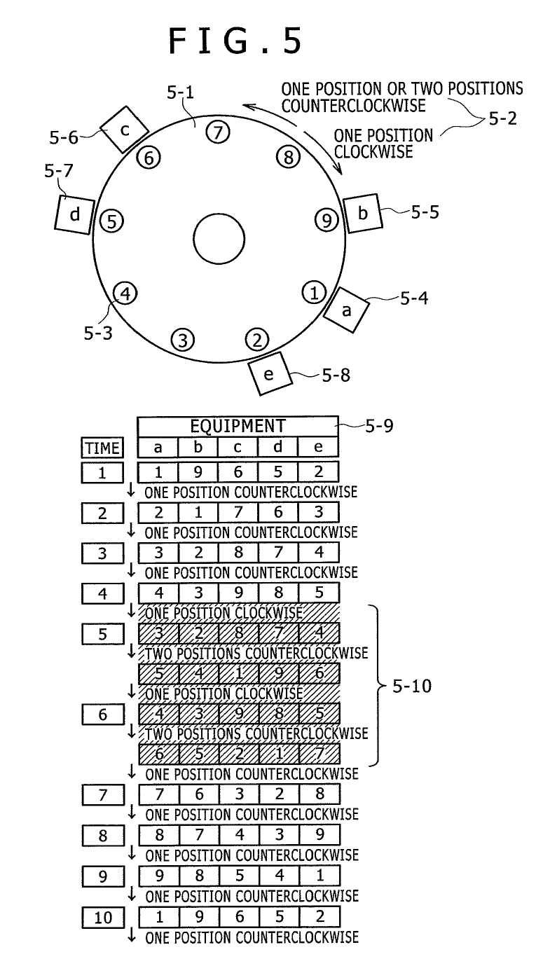

The present invention prepares a plurality of different operational patterns of the reaction vessel transport mechanism and selectively uses them as needed to achieve the intended purpose. A concrete example is shown in FIG. 5. It is assumed that the reaction vessel transport mechanism operates in three different patterns, that is, rotates one position counterclockwise, rotates one position clockwise, or rotates two positions counterclockwise.

If analyses are to be successively made in one type of measurement sequence, the reaction vessel transport mechanism operates in a conventional manner, that is, rotates one position counterclockwise. If, on the other hand, analyses are to be made in different measurement sequences, the reaction vessel transport mechanism switches to a different pattern, that is, for example, rotates one position clockwise and then two positions counterclockwise within a predetermined period of time, to execute the different measurement sequences. If an analysis is initiated in measurement sequence B while an analysis is made in measurement sequence A, the reaction vessel transport mechanism operates in a pattern different from a pattern used in the measurement sequence (measurement sequence A) shown in FIG. 3 only during a time zone indicated at 5-10 in FIG. 5. During the time zone indicated at 5-10, the process performed in measurement sequence A differs from the process performed in measurement sequence B. During the other time zones, however, the use of only one mechanism control operation sequence will suffice.

A method of avoiding the simultaneous use of mechanical equipment necessary for analyses and the interference between the mechanical equipment in a situation where different types of measurement sequences coexist will now be described.

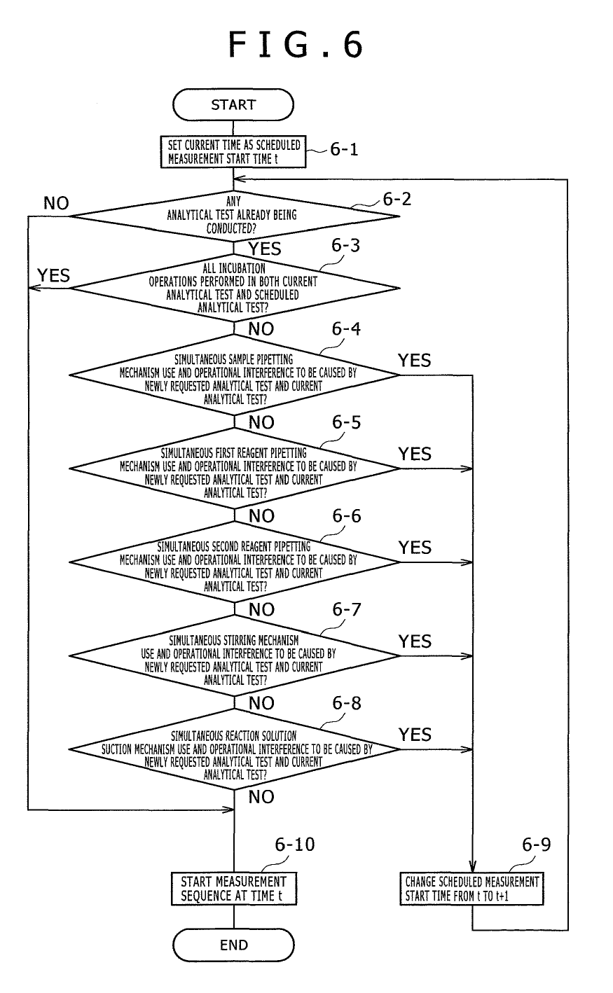

If only one type of measurement sequence is used to conduct a plurality of analytical tests in a parallel manner, analyses are made efficiently without simultaneous mechanical equipment use because the mechanical equipment is used at fixed time intervals for various analytical tests as shown in FIG. 2. However, if different measurement sequences coexist, the mechanical equipment may be used at the same time for various analytical tests. This may cause, for instance, the collision of mechanisms or the discontinuation of an analysis. To avoid such a problem, the present invention incorporates a logic that operates when two different measurement sequences coexist, checks for the simultaneous use of mechanical equipment for analytical tests and the interference between the mechanical equipment, and postpones the start of a sequence until it is possible to avoid the simultaneous use of mechanical equipment and the interference between the mechanical equipment. FIG. 6 is a flowchart illustrating the logic.

First of all, when a request for an analytical test is newly generated, the automatic analyzer performs step 6-1 to set the current time as scheduled measurement start time t.

Next, the automatic analyzer performs step 6-2 to check whether any analytical test is already being conducted. If no analytical test is being conducted, the automatic analyzer proceeds to step 6-10 and immediately starts a scheduled measurement sequence. If, on the other hand, any analytical test is being conducted, the automatic analyzer proceeds to step 6-3.

Step 6-3 is performed to judge whether a current analytical test and a scheduled analytical test both involve all incubation operations. If the judgment result obtained in step 6-3 indicates that the current and scheduled analytical tests both involve all incubation operations, the automatic analyzer proceeds to step 6-10 and immediately executes the scheduled measurement sequence. If, on the other hand, the judgment result obtained in step 6-3 does not indicate that the current and scheduled analytical tests both involve all incubation operations, the automatic analyzer proceeds to step 6-4 and checks whether the newly requested analytical test and the current analytical test are about to use the sample pipetting mechanism at the same time. If they are about to use the sample pipetting mechanism at the same time, the automatic analyzer proceeds to step 6-9. If not, the automatic analyzer proceeds to step 6-5.

In step 6-5, the automatic analyzer checks whether the newly requested analytical test and the current analytical test are about to use the first reagent pipetting mechanism at the same time. If they are about to use the first reagent pipetting mechanism at the same time, the automatic analyzer proceeds to step 6-9. If not, the automatic analyzer proceeds to step 6-6.

In step 6-6, the automatic analyzer checks whether the newly requested analytical test and the current analytical test are about to use the second reagent pipetting mechanism at the same time. If they are about to use the second reagent pipetting mechanism at the same time, the automatic analyzer proceeds to step 6-9. If not, the automatic analyzer proceeds to step 6-7.

In step 6-7, the automatic analyzer checks whether the newly requested analytical test and the current analytical test are about to use the stirring mechanism at the same time. If they are about to use the stirring mechanism at the same time, the automatic analyzer proceeds to step 6-9. If not, the automatic analyzer proceeds to step 6-8.

In step 6-8, the automatic analyzer checks whether the newly requested analytical test and the current analytical test are about to use the reaction solution suction mechanism at the same time. If they are about to use the reaction solution suction mechanism at the same time, the automatic analyzer proceeds to step 6-9. If not, the automatic analyzer proceeds to step 6-10.

In step 6-9, the automatic analyzer concludes that the currently scheduled measurement start time involves the simultaneous use of mechanical equipment, postpones the start of the measurement sequence by changing the scheduled measurement start time from t to t+1, and returns to step 6-2.

In step 6-10, the automatic analyzer starts the measurement sequence at the scheduled measurement start time t.

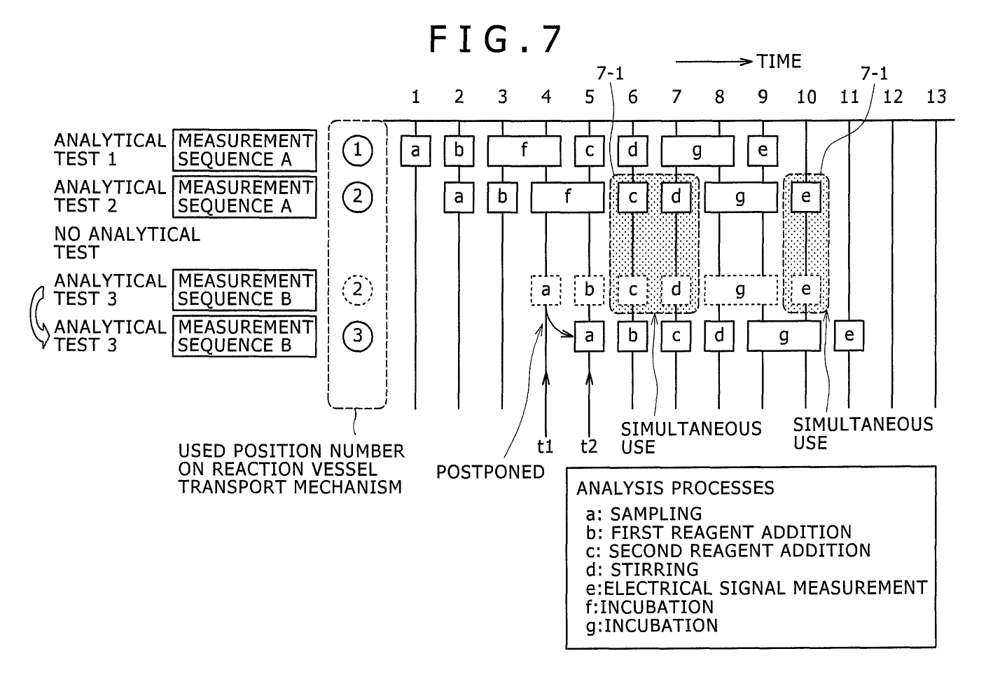

FIG. 7 shows an example in which the logic shown in FIG. 6 is applied to postpone the start of a sequence until it is possible to avoid the simultaneous use of mechanical equipment and the interference between the mechanical equipment. FIG. 7 indicates that an attempt is made to start a new analytical test (analytical test 3) at time t1 while preceding analytical tests (analytical tests 1 and 2) are being conducted.

If an attempt is made to start analytical test 3 at time t1 as scheduled, the second reagent addition, stirring, and electrical signal measurement processes coincide during time zones indicated at 7-1. It means that the second reagent pipetting mechanism, stirring mechanism, and reaction solution suction mechanism would be used at the same time. When the aforementioned logic is applied to this situation, the start of analytical test 3 is postponed from time t1 to time t2 to avoid simultaneous use of the mechanisms.

Further, for a situation where measurements are to be made to conduct a plurality of analytical tests, the automatic analyzer incorporates a logic that postpones the start of measurements that cannot be made at time t, and proceeds to make measurements that can be made.

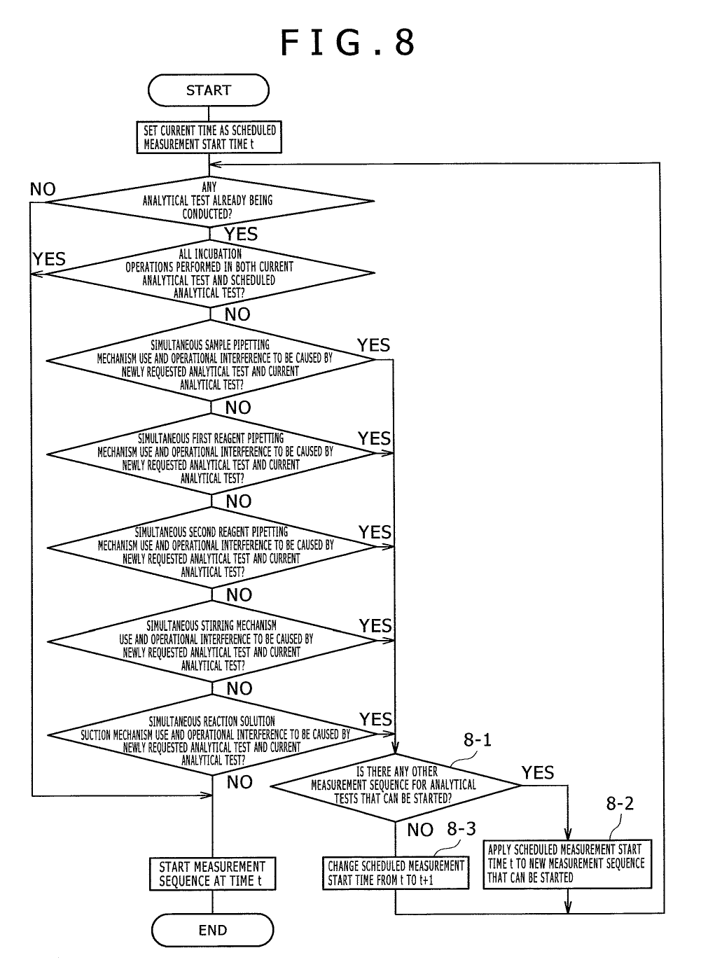

FIG. 8 is a flowchart illustrating a logic that incorporates a function of postponing the start of a sequence until it is possible to avoid the simultaneous use of mechanical equipment and the interference between the mechanical equipment as indicated in FIG. 6 and a function of checking for an additional analytical test that is to be conducted. In step 8-1, the automatic analyzer checks for an additional analytical test that is to be conducted. If an additional analytical test is to be conducted, the automatic analyzer proceeds to step 8-2, the automatic analyzer applying a new measurement sequence capable for starting for the analytical test, and checks again for simultaneous equipment use. If, on the other hand, no additional analytical test is to be conducted, the automatic analyzer proceeds to step 8-3 and postpones the start of the sequence by changing the scheduled measurement start time for the first analytical test to be conducted from t to t+1. When the above logic is applied, analytical tests that can be conducted will be initiated prior to the other analytical tests. This ensures that the apparatus can be operated with increased efficiency.

### DESCRIPTION OF REFERENCE NUMERALS

1-1, 3-1, 5-1 . . . Reaction vessel transport mechanism
1-2 . . . Reaction vessel setting position
1-3 . . . Reaction vessel
1-4 . . . Sample pipetting mechanism
1-5, 3-5, 5-5 . . . First reagent pipetting mechanism
1-6, 3-6, 5-6 . . . Second reagent pipetting mechanism
1-7, 3-7, 5-7 . . . Stirring mechanism
1-8, 3-8, 5-8 . . . Reaction solution suction mechanism
1-9 . . . Sample vessel
1-10 . . . First reagent vessel
1-11 . . . Second reagent vessel
1-12 . . . Detector
1-13 . . . Measurement sequence A
1-14 . . . Measurement sequence B
3-2, 5-2 . . . Rotation direction and number of rotational positions of reaction vessel transport mechanism
3-3, 5-3 . . . Reaction vessel setting position and number
3-4, 5-4 . . . Sample pipetting mechanism
3-9, 5-9 . . . Diagram indicating the numbers of reaction vessel setting positions that stop at various mechanical equipment positions at fixed time intervals
5-10 . . . Time zone during which the reaction vessel transport mechanism is subjected to different operation control and operated in a different rotation direction or by a different rotation amount in order to allow different sequences to coexist
7-1 . . . Timing at which simultaneous mechanical equipment use results when different measurement sequences coexist

1. An automatic analyzer having a measurement sequence including a series of operations, comprising at least one of sample sampling, reagent addition, stirring, incubation, and electrical signal measurement, for analyzing a target component in a sample and for discretely initiating the measurement sequence at constant time intervals to conduct a plurality of analytical tests coincidentally,
wherein the automatic analyzer is capable of executing at least two different measurement sequences.

2. The automatic analyzer according to claim 1,
wherein the automatic analyzer is capable of executing at least two different measurement sequences that differ in the length of time of an incubation process in a measurement sequence, that is, the length of time of chemical reaction.

3. The automatic analyzer according to claim 2,
wherein the automatic analyzer has a plurality of reaction vessel transport control schemes for mechanical equipment that performs various operations, such as sample sampling, reagent addition, stirring, incubation, and electrical signal measurement, and makes analyses by executing two or more different measurement sequences in a sequential, parallel manner.

4. The automatic analyzer according to claim 3,
wherein measurement start timing in different measurement sequences is assigned to the discrete start timing so that the automatic analyzer can execute the two or more different measurement sequences in a random order and combination.

5. The automatic analyzer according to claim 4,
wherein the two or more different measurement sequences are measurement sequences in which various analytical operations are performed in accordance with electrical signal measurement in the sequences; wherein a differently timed measurement operation is properly timed by employing a different reaction vessel transport control scheme; and wherein mechanism control for a period later than the start of measurement by a fixed interval can be exercised in only one sequence.

6. The automatic analyzer according to claim 1, comprising:
control means for checking mechanical equipment required for measurement processes, such as sample sampling, reagent addition, stirring, incubation, and electrical signal measurement to avoid simultaneous use of mechanical equipment and operational interference between the mechanical equipment when two or more different measurement sequences are to be coincidentally executed with step by step.

7. The automatic analyzer according to claim 6, further comprising:
control means for postponing a scheduled start measurement sequences and for starting a measurement sequence irrelevant to a simultaneous use and an operational interference prior to the scheduled start measurement sequences, when the simultaneous use of mechanical equipment necessary for the processes and the operational interference between the mechanical equipment are to be occurred.
